(19) United States
(12) Patent Application Publication
(10) Pub. No.: US 2008/0244118 A1
(43) Pub. Date: Oct. 2, 2008

(54) METHOD AND APPARATUS FOR SHARING BUFFERS

(76) Inventors: JOS MANUEL ACCAPADI, Austin, TX (US); VANDANA MALLEMPATI, Austin, TX (US)

Correspondence Address: IBM CORP (YA);C/O YEE & ASSOCIATES PC, P.O. BOX 802333, DALLAS, TX, 75380, US

(21) Appl. No.: 11/692,579

(22) Filed: Mar. 28, 2007

(51) Int. Cl. G06F 3/00

(52) U.S. Cl. 710/56

(57) ABSTRACT

A computer implemented method, apparatus, and computer usable program product are provided for managing a plurality of buffers in a data processing system. A requester component requests a free buffer of a certain size. A buffer agent determines whether a set of free buffers, whose combined size is equal to or greater than the requested buffer size, is available from a set of donor components. If the set of free buffers is available, the buffer agent combines the free buffers into a combined free buffer of size equal to or greater than the requested size, and removes the free buffers from a free buffer list of a corresponding donor component. The buffer agent then allocates the combined free buffer to the requester component.

### BACKGROUND OF THE INVENTION

1. Field of the Invention

The present invention relates generally to an improved data processing system, and in particular, to a computer implemented method, apparatus, and computer usable program code for managing memory in a data processing system. Still more particularly, the present invention relates to a computer implemented method, apparatus, and computer usable program code for improving the performance of a data processing system by sharing free buffers among the data processing system components.

2. Description of the Related Art

Data processing systems allocate portions of memory to various data processing system components so that the data processing system components may read and write data using the allocated portion of the memory. The data processing system components can be hardware, software, or a combination of hardware and software. Some examples of data processing system components are the graphics adapter, the network adapter, and the operating system kernel. Several other data processing system components, not limited to the examples listed above, are conceivable in a specific data processing system configuration.

Some data processing system components, especially the hardware components, may have on-board memory. This type of memory is memory that is built into the hardware component for the component's use. A data processing system may allocate portions of the on-board memory as well as system memory to certain data processing system components.

The data processing system components use the allocated memory in performing their function by reading and writing blocks of the allocated memory. A block of memory of a specific size that a data processing system component reads and writes in this manner is called a buffer. The specific size of the block is the size of the buffer, or buffer size. Thus, a data processing system allocates a number of buffers to a data processing system component in allocating a portion of the memory to that data processing system component.

As the data processing system components perform their functions, the data processing system components use up their allocated buffers when needed and free up the buffers when the data in those buffers is no longer needed. Occasionally, a data processing system component may use all of the allocated buffers. In such a case, continued operation of the data processing system component may result in a demand for more buffers when no buffers are available for new data.

When the demand for buffers in the data processing system component exceeds the supply of buffers allocated to the data processing system component, the data processing system component has to wait until one or more buffers allocated to the data processing system component become available to continue operation. Waiting for buffers slows the operation of the data processing system component. This slow down results in a degradation in the performance of the data processing system as a whole.

### SUMMARY OF THE INVENTION

The illustrative embodiments provide a computer implemented method, apparatus, and computer usable program product for managing a plurality of buffers in a data processing system. A requestor component requests a free buffer of a first size. A determination is made whether a set of free buffers, whose combined size is equal to or greater than the first size, is available from a set of donor components. If the set of free buffers is available, the free buffers in the set of free buffers are combined to result in a combined free buffer of a combined size that is equal to or greater than the first size. Each of the free buffers in the set of free buffers is removed from a free buffer list of a corresponding donor component. The combined free buffer is allocated to the requester component.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts an exemplary diagram of a data processing environment for implementing an illustrative embodiment;

FIG. 2 depicts a block diagram of data processing system components in a data processing system corresponding to the data processing system components' allocated buffers in accordance with an illustrative embodiment;

FIG. 3 depicts a block diagram of data processing system components sharing buffers in accordance with an illustrative embodiment;

FIG. 4 depicts a table of shared buffers in accordance with an illustrative embodiment;

FIG. 5 depicts a flowchart of the process of requesting additional buffers in accordance with an illustrative embodiment;

FIG. 6 depicts a flowchart of a process for handling buffer requests in accordance with an illustrative embodiment;

FIG. 7 depicts a flowchart of a process of responding to a free buffer availability inquiry in accordance with an illustrative embodiment; and

FIG. 8 depicts a flowchart of a process for returning the shared free buffers to the correct donor components in accordance with an illustrative embodiment.

### DETAILED DESCRIPTION OF THE PREFERRED EMBODIMENT

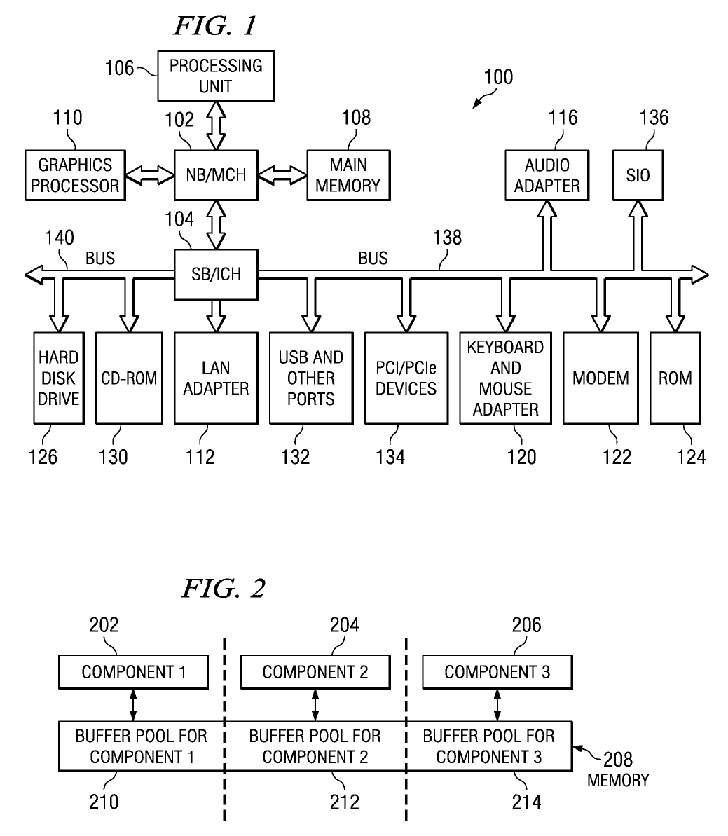

With reference now to the figures and in particular with reference to FIG. 1, the figure provides an exemplary diagram of a data processing environment for implementing illustrative embodiments. Note that FIG. 1 is only exemplary and does not assert or imply any limitation with regard to the environments for implementing different embodiments. One of ordinary skill in the art may make many modifications to the depicted environments.

Turning now to FIG. 1, the figure depicts a block diagram of a data processing system in which illustrative embodiments may be implemented. Data processing system 100 is an example of a computer in which code or instructions implementing the processes of the illustrative embodiments may be located.

In the depicted example, data processing system 100 employs a hub architecture including a north bridge and memory controller hub (NB/MCH) 102 and a south bridge and input/output (I/O) controller hub (SB/ICH) 104. Processing unit 106, main memory 108, and graphics processor 110 are coupled to north bridge and memory controller hub (NB/MCH) 102. Processing unit 106 may contain one or more processors and even may be implemented using one or more heterogeneous processor systems. Graphics processor 110 may be coupled to the NB/MCH through an accelerated graphics port (AGP), for example.

In the depicted example, local area network (LAN) adapter 112 is coupled to south bridge and I/O controller hub (SB/MCH) 104, audio adapter 116, keyboard and mouse adapter 120, modem 122, read only memory (ROM) 124, universal serial bus (USB) and other ports 132. PCI/PCIe devices 134 are coupled to south bridge and I/O controller hub (SB/MCH) 104 through bus 138. Hard disk drive (HDD) 126 and CD-ROM 130 are coupled to south bridge and I/O controller hub (SB/MCH) 104 through bus 140.

PCI/PCIe devices 134 may include, for example, Ethernet adapters, add-in cards, and PC cards for notebook computers. PCI uses a card bus controller, while PCIe does not. Read only memory (ROM) 124 may be, for example, a flash binary input/output system (BIOS). Hard disk drive 126 and CD-ROM 130 may use, for example, an integrated drive electronics (IDE) or serial advanced technology attachment (SATA) interface. A super I/O (SIO) device 136 may be coupled to south bridge and I/O controller hub (SB/MCH) 104.

An operating system runs on processing unit 106. This operating system coordinates and controls various data processing system components within data processing system 100 in FIG. 1. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 100. (Java™ and all Java™-based trademarks are trademarks of Sun Microsystems, Inc. in the United States, other countries, or both).

Instructions for the operating system, the object-oriented programming system, and applications or programs are located on storage devices, such as hard disk drive 126. These instructions may be loaded into main memory 108 for execution by processing unit 106. The processes of the illustrative embodiments may be performed by processing unit 106 using computer implemented instructions, which may be located in a memory. An example of a memory is main memory 108, read only memory (ROM) 124, or in one or more peripheral devices.

The hardware shown in FIG. 1 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1. Additionally, the processes of the illustrative embodiments may be applied to a multiprocessor data processing system.

The systems and data processing system components shown in FIG. 1 can be varied from the illustrative examples shown. In some illustrative examples, data processing system 100 may be a personal digital assistant (PDA). A personal digital assistant generally is configured with flash memory to provide a non-volatile memory for storing operating system files and/or user-generated data. Additionally, data processing system 100 can be a tablet computer, a laptop computer, or a telephone device.

Other data processing system components shown in FIG. 1 can be varied from the illustrative examples shown. For example, a bus system may be comprised of one or more buses, such as a system bus, an I/O bus, and a PCI bus. Of course, the bus system may be implemented using any suitable type of communications fabric or architecture that provides for a transfer of data between different data processing system components or devices attached to the fabric or architecture. Additionally, a communications unit may include one or more devices used to transmit and receive data, such as a modem or a network adapter. Further, a memory may be, for example, main memory 108, or a cache such as found in north bridge and memory controller hub (NB/MCH) 102. Also, a processing unit may include one or more processors or CPUs.

The depicted examples in FIG. 1 are not meant to imply architectural limitations. In addition, the illustrative embodiments provide for a computer implemented method, an apparatus, and a computer usable program code for compiling source code and for executing code. The methods described with respect to the depicted illustrative embodiments may be performed in a data processing system, such as data processing system 100 shown in FIG. 1.

A data processing system allocates portions of memory to the various data processing system components for the data processing system components to perform their respective functions. The data processing system components can be graphics processor 110, LAN adapter 112, audio adapter 116, and modem 122 depicted in FIG. 1, among other data processing system components similarly found in a data processing system. The memory can be main memory 108 as shown in FIG. 1.

The data processing system components read and write blocks of allocated memory. The blocks of memory used in this manner are called buffers. Thus, the allocated memory is divisible into blocks of a size used by the data processing system component, resulting in a number of buffers being allocated to the data processing system component. This collection of a number of buffers allocated to the data processing system component is also referred to as a buffer pool. In the illustrative embodiments, a buffer containing data that is being used by a data processing system component is a buffer in use. A buffer not containing data that is being used by the data processing system component is an available free buffer in these examples. Thus, the buffer pool can be further classified as the free buffer pool, which is a pool of free buffers, and the in use buffer pool, which is a pool of buffers in use.

The data processing system allocates portions of memory, and therefore buffers, to several data processing system components. As described above, data processing system components can be hardware, software, or a combination thereof. The memory can be the data processing system's main memory, on-board memory on a specific data processing system component, or any other memory available to a data processing system for allocation to various data processing system components. Each portion of memory is exclusively allocated to a data processing system component, and the data processing system component manages the data processing system component's buffers within that exclusively allocated memory. A data processing system component uses a buffer in that allocated memory when needed, and frees a buffer in that allocated memory when the data in the buffer is not needed.

In a data processing system component, when demand for buffers exceeds the supply of available free buffers, the operation of the data processing system component is affected. The excess demand for buffers can cause the data processing system component to wait for buffers to become available. This waiting for buffers can result in the data processing system component's operation slowing down. This slow down in the operation of the data processing system component can result in a deterioration in the performance of the data processing system as a whole. For example, a graphics card waiting for buffers can cause a slow refresh of the display screen of the data processing system. As another example, a network card waiting for buffers can cause a data processing system to experience slow network speeds.

Illustrative embodiments recognize that while one data processing system component experiences a shortage of buffers, another data processing system component may have free buffers available for use. However, because the buffers are presently used only by the data processing system component to which they are allocated, the availability of free buffers in one data processing system component does not alleviate the shortage of buffers in another data processing system component. Therefore, a method and an apparatus for sharing available free buffers among data processing system components will be useful. Illustrative embodiments provide a method, apparatus, and computer program product for sharing buffers. The illustrative embodiments identify available free buffers allocated to one or more data processing components. The illustrative embodiments then provide a mechanism for re-allocating those free buffers to a different data processing system component that may be experiencing a buffer shortage.

With reference now to FIG. 2, a block diagram of data processing system components in a data processing system corresponding to allocated buffers for data processing system components is depicted in accordance with an illustrative embodiment. Data processing system components 202, 204, and 206 are data processing system components in a data processing system, such as graphics processor 110, LAN adapter 112, audio adapter 116, and modem 122 in FIG. 1.

The data processing system, to which data processing system components 202-206 belong, allocates buffers for each data processing system component 202-206. The allocated buffers are located in memory 208, which can be implemented using main memory 108 in FIG. 1. The data processing system may allocate these buffers in addition to, or in place of, any on-board memory a particular data processing system component may have. Furthermore, memory 208 may include other memory regions and memory devices available to the data processing system for allocating in this manner. Thus, memory 208 can include all memory available to a data processing system for allocating to the various data processing system components.

FIG. 2 shows areas of memory 208 as allocated to specific data processing system components. Memory area 210 is shown to be the allocated buffer pool for data processing system component 202; memory area 212 is shown to be the allocated buffer pool for data processing system component 204; and memory area 214 is shown to be the allocated buffer pool for data processing system component 206.

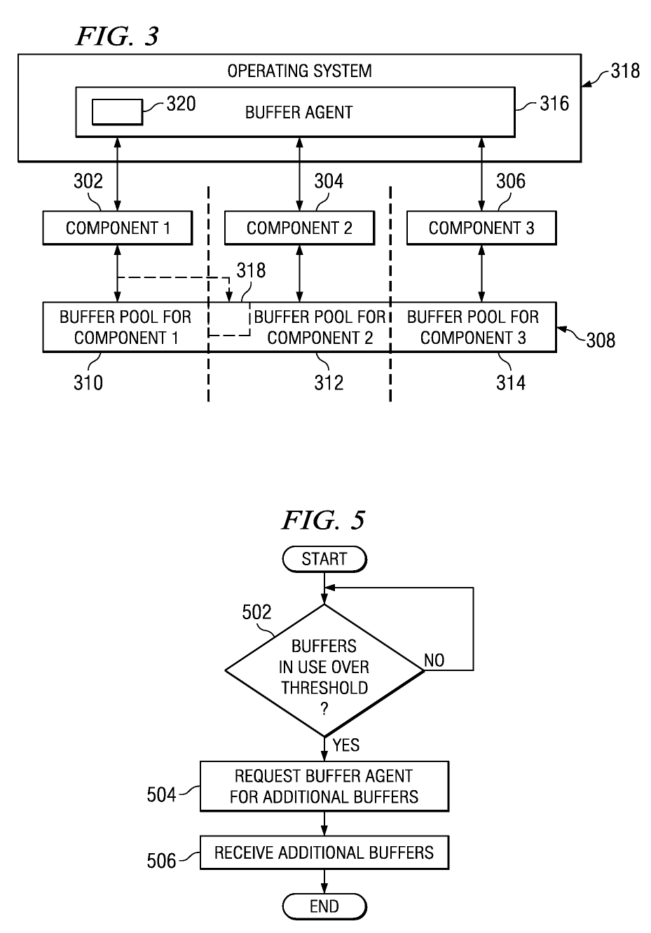

With reference now to FIG. 3, this figure depicts a block diagram of data processing system components sharing buffers in accordance with an illustrative embodiment. Data processing system components 302, 304, and 306 can be implemented similar to data processing system components 202, 204, and 206 in FIG. 2.

The data processing system to which data processing system components 302-306 belong allocates buffers for each data processing system component in memory 308, which can be implemented similar to memory 208 in FIG. 2, in addition to or in place of any on-board memory a particular data processing system component may have. FIG. 3 shows areas of memory 308 as allocated to specific data processing system components. Memory area 310 is allocated for use as buffers by data processing system component 302; memory area 312 is allocated for use as buffers by data processing system component 304; and memory area 314 is allocated for use as buffers by data processing system component 306. Each memory area 310-314 allocated in this manner is a buffer pool.

FIG. 3 depicts buffer agent 316, which is capable of communicating with the various data processing system components in a data processing system. Buffer agent 316 is depicted as running under operating system 318.

Buffer agent 316 can be implemented as a kernel thread running within the operating system of the data processing system. A kernel thread is a form of a process running within the operating system kernel. Kernel threads have associated priorities within the operating system. A user, such as a system administrator, can designate a particular thread as a high priority thread or a low priority thread. In a particular embodiment, the buffer agent can be made to run as a high priority kernel thread. The buffer agent is shown to run under an operating system, and described to be a kernel thread only as exemplary. Specific configurations of the illustrative embodiment can implement the depicted buffer agent in other forms and elsewhere in a data processing system without departing from the spirit of the illustrative embodiment.

FIG. 3 shows buffer agent 316 in communication with data processing system components 302-306; however, any data processing system component that uses buffers in a data processing system can be configured to communicate with buffer agent 316. Data processing system components 302-306 are depicted only as exemplary for the clarity of the description of the illustrative embodiment, and are not intended to be limiting on the illustrative embodiment.

When a data processing system component faces a shortage of buffers, the data processing system component can communicate to the buffer agent a need for additional buffers. For example, a data processing system component can communicate with the buffer agent using interrupts, calling a function implemented in the buffer agent, such as an application programming interface (API), a remote procedure call (RPC). Furthermore, existing data processing system components can be modified to communicate with the buffer agent of the illustrative embodiment using one of these exemplary communication methods, or other commonly known methods for such communications.

A data processing system component can determine if additional buffers are needed under a variety of circumstances. For example, a data processing system component may fully exhaust all free buffers in the data processing system component's buffer pool for determining that additional buffers are needed. Alternatively, a data processing system component may achieve a level of usage, such as when a preset percentage of the buffer pool is in use, for determining that additional buffers are needed. The level of usage that triggers this determination is called a threshold level of usage. These ways of determining that additional buffers are needed are described here only as exemplary, and are not intended to be limiting on the illustrative embodiment. A particular mechanism for determining whether additional buffers are needed will depend on the particular implementation.

Continuing with the description of FIG. 3, as an example, data processing system component 302 can communicate to buffer agent 316, a need for additional buffers when data processing system component 302 has exceeded a threshold level of usage of buffer pool 310. Buffer agent 316 communicates the request from data processing system component 302 to other data processing system components that are in communication with buffer agent 316. In this example, data processing system component 304 has available free buffers 318 in main area 312, that data processing system component 304 can share with data processing system component 302. Data processing system component 304 communicates to buffer agent 316 the sharability of free buffers 318. Buffer agent 316 performs the necessary processing to make free buffers 318 available to data processing system component 302.

The data processing system component sharing the data processing system component's free buffers is called a donor component. The data processing system component requesting additional buffers is called a requester component. As described above, a data processing system component reads and writes data in the allocated memory in blocks of a certain size. This size of the data block is therefore the size of the buffer that the particular data processing system component uses.

Each data processing system component can potentially have a buffer size that is different from the buffer size used by another data processing system component. Consequently, when a requester component sends a request for additional buffers to the buffer agent, a donor component may share a buffer that is of a different size. If the donor component's buffer is smaller than the buffer size used by the requester component, several of the donor component's buffers may be combined to create a buffer of the buffer size used by the requestor component.

As a variation of the above exemplary circumstance, a set of donor components may respond to a request for additional buffer by a requestor component. A set of components is one or more components. A set of donor components is one or more donor components.

Because each donor component could be using buffers of different sizes, and their shared free buffers are in different parts of the allocated memory, those shared free buffers have to be logically combined to create a buffer of the size used by the requestor component. Buffer agent 316 in FIG. 3 provides the logic and processing necessary for combining free buffers in the manner described above.

Furthermore, in some instances, a single data processing system component can use buffers of different sizes. Data processing system components refer to buffers by buffer types. A buffer type is a name used by a data processing system component to refer to a buffer with a certain characteristic, such as a certain size. A donor component may share multiple buffers of different buffer types, or several donor components may share buffers of different buffer types.

Furthermore, a donor component may designate some buffers in its buffer pool as not sharable and other buffers in its buffer pool as sharable. For example, a donor component may designate only a part of its buffer pool to be sharable so that the donor component has sufficient buffers available at all times in its buffer pool regardless of the shared buffers. The buffers that the data processing system component decides to share are called sharable buffers. Sharable buffers that are free and available for sharing are free sharable buffers.

A data processing system component may maintain a list of free sharable buffers in a free buffer list. A free buffer list is a listing of the free buffers that are available in a data processing system component's buffer pool.

A sharable buffer may not be free for at least two reasons. The sharable buffer may have already been shared, or the sharable buffer may have been used up the data processing system component to whose buffer pool the sharable buffer belongs. Other reasons for non-availability of free sharable buffers will depend on specific implementations.

Furthermore, some data processing system components may not share any buffers at all. For example, if a data processing system component has a critical role in uninterrupted operation of the data processing system, such a data processing system component may be configured to not share any buffers from its buffer pool.

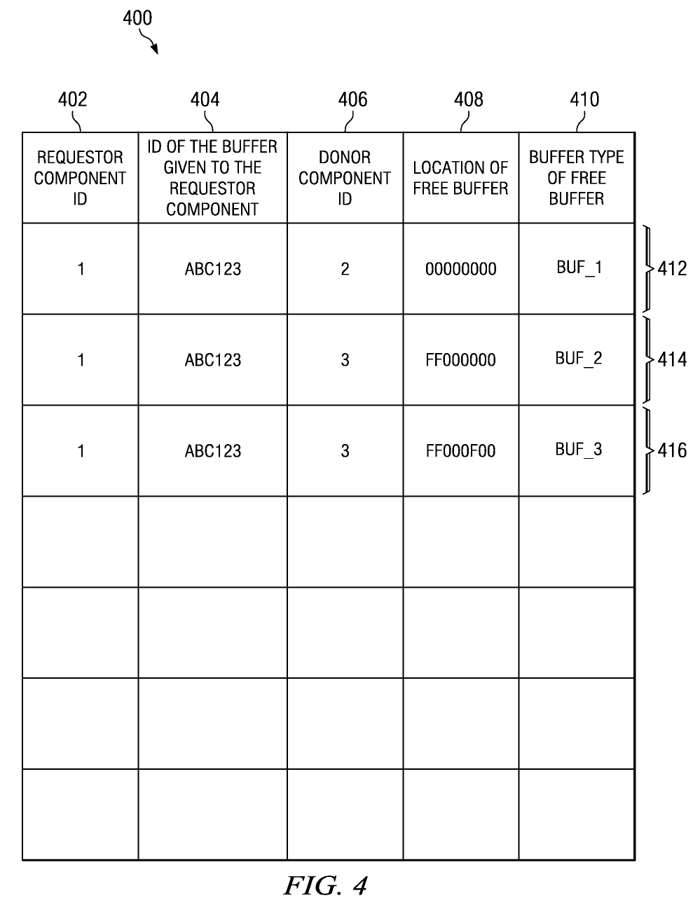

Buffer agent 316 in FIG. 3 provides the necessary processing for keeping track of the details of the shared buffers. For example, a buffer agent may maintain a table of shared buffers. FIG. 3 depicts table 320 used by buffer agent 316 in this manner. The description of FIG. 4 below provides the detailed view of an exemplary implementation of table 320. Among several possible implementations, the table can take the form of a database table, a file, or a list in memory. When a data processing system component shares a buffer, the buffer agent can make an entry into the table, noting the identity of the donor component, and the location, size, and buffer type of the shared buffer.

Buffer agent 316 in FIG. 3 provides the necessary processing for returning the shared buffers to their respective data processing system components when the shared buffer is returned by the requesting component after use. Just like several buffers may have to be combined to form a buffer of a size used by the requester component, a buffer being returned by the requester component after use may have to be broken down into several buffers for return to the donor components.

The buffer agent provides the necessary processing for this breakdown process. The buffer agent uses the entries in the table of shared buffers to identify the composition of the returned buffer so that buffers of correct size and buffer type can be broken out of the returned buffer and returned to the correct donor components that shared the free buffers in the returned buffer.

The above description conceptually describes the functionality of the buffer agent. The description is only exemplary, is used in the manner described above for clarity, and is not intended to be limiting on the illustrative embodiments. The described functionality can be implemented in a number of configuration specific ways from this disclosure.

Furthermore, the above description uses a request for a single additional buffer as a simplified example for clarity of the illustrative embodiment. The illustrative embodiment may be implemented such that the request from a requester component is for a set of buffers. A set of buffers is one or more buffers.

With reference now to FIG. 4, this figure depicts a table of shared buffers in accordance with an illustrative embodiment. This table is a more detailed view of table 320 in FIG. 3. The depicted table is an exemplary table that a buffer agent, such as buffer agent 316 in FIG. 3, can maintain for sharing free buffers from donor components to requester components.

Table 400 includes several columns that are used by the buffer agent for maintaining appropriate record of shared buffers. Note that the depicted columns are only exemplary and not intended to be limiting on the illustrative embodiment. One of ordinary skill in the art will be able to implement the table in the form depicted, or a modified form with more or fewer columns without departing from the spirit of the illustrative embodiment.

Entries in column 402 are the identifiers of a requester component. Entries in column 404 are the identifiers of the buffer allocated to the requestor component of column 402. Entries in column 406 are identifiers of the donor components that have shared free buffers for the buffer identified in column 404. Column 408 contains the identifier of those free buffers, which in the depicted example is the location of those free buffers. Column 410 contains the buffer type of those free buffers.

As described above, more than one free buffer may be combined from more than one donor component to allocate an additional buffer of a size sufficient for the requester component. In the exemplary entries depicted in rows 412, 414, and 416, an additional buffer requested by a requester component is created by combining several free buffers from several donor components.

The entries in rows 412-416 show that a buffer identified by identifier ABC123 is given to requester component 1 in response to a request for an additional buffer by data processing system component 1. The entries in rows 412-416 further show that buffer ABC123 includes a free buffer at memory address 00000000, of buffer type BUF_{—}1, belonging to data processing system component 2. Buffer ABC123 further includes two free buffers from data processing system component 3, one located at memory address FF000000 and being of buffer type BUF_{—}2, and the other being located at memory address FF000F00 and being of buffer type BUF_{—}3.

The entries shown in table 400 are only exemplary and shown for the clarity of the description of the illustrative embodiment. From this disclosure, one of ordinary skill in the art will be able to modify the actual entries in the table, the implementation of the table, and the columns of the table according to specific implementation of the illustrative embodiment.

With reference now to FIG. 5, this figure depicts a flowchart of the process of requesting additional buffers in accordance with an illustrative embodiment. The process of requesting additional buffers can be implemented in a data processing system component, such as data processing system components 302-306 in FIG. 3.

The process begins by determining if the number of buffers in use by the buffer pool allocated to the data processing system component exceeds the threshold level of usage (step 502). Particular implementations of this process may alter step 502 to determine if the number of buffers in use is approaching the threshold level of usage, is at the threshold level of usage, or has exceeded the threshold level of usage, without departing from the spirit of the illustrative embodiment.

If the determination in step 502 is negative (“no path of step 502), the process repeats the determination. The repeat of step 502 can be set on a schedule, or by detecting certain events. For example, a user, such as an administrator of the data processing system, may set a schedule for the determination of step 502. Alternatively, the user may configure the process such that step 502 repeats when an event, such as an interrupt, or a certain time delay in functioning of the data processing system component, is encountered. Several implementation specific ways for repeating step 502 will be conceivable from this disclosure.

If the determination in step 502 is positive (“yes” path of step 502), the process requests a buffer agent, such as buffer agent 316 in FIG. 3, for additional buffers (step 504). The process receives additional one or more buffers form the buffer agent (step 506). The process ends thereafter.

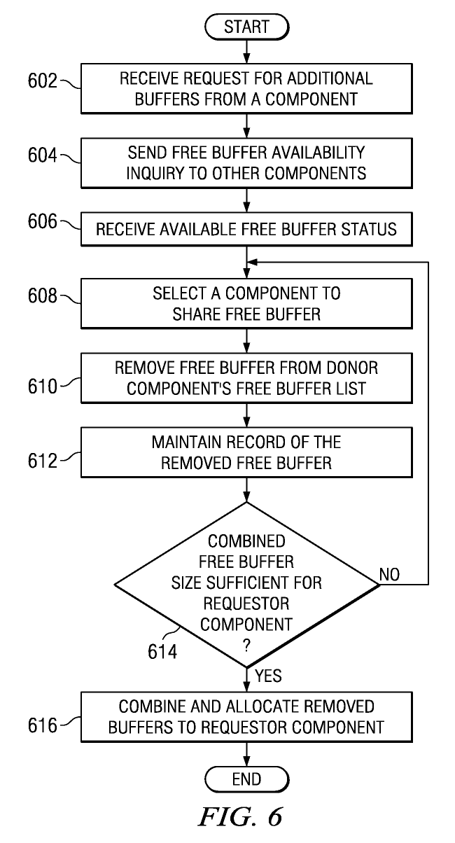

With reference now to FIG. 6, this figure depicts a flowchart of a process for handling buffer requests in accordance with an illustrative embodiment. The process for handling buffer requests can be implemented in a buffer agent, such as buffer agent 316 in FIG. 3.

The process begins by receiving a request for an additional buffer from a data processing system component, such as any one of data processing system components 302-306 in FIG. 3, (step 602). The process sends an inquiry to data processing system components that the process is in communication with other data processing system components, for availability of free buffers for sharing (step 604).

In response to the inquiry sent to one or more data processing system components in step 604, the process receives availability status of free buffers from those data processing system components (step 606). Next, depending on the availability status from the various data processing system components, the process selects a set of one or more donor components, from which to share a set of free buffers (step 608). A set of free buffers is one or more free buffers.

Each free buffer in the set of free buffers has a corresponding donor component in the set of data processing system components. The process may identify more donor components in the set of data processing system components than are needed to form the requested additional buffer. The process may also identify more free buffers in the set of free buffers than are needed to form the requested additional buffer. Formation of the requested additional buffer is described in further detail in the steps below.

The process removes the free buffers shared by the one or more donor components from those donor components' free buffers list (step 610). The removed free buffers may be a subset of the set of free buffers. A subset of free buffers is a set of one or more free buffers, not exceeding the total number of free buffers in the set of free buffers.

The process maintains a record of the free buffers shared by the various data processing system components. The record may be a table with entries corresponding to the free buffers shared by the various donor components in response to the request from various requestor components. As described in the above example, the table entries may include, among other data, the identity of the donor component, identity of the free buffer, size of the free buffer, and buffer type of the free buffer. The identity of the free buffer may be the address of the free buffer in the memory. After removing, or simultaneously with the removal of a free buffer from a donor component's free buffers list, the process updates the record with the information about the removed free buffer (step 612).

The process then determines if the free buffer removed in step 610 is of a size equal to or greater than the buffer size requested by the requestor component (step 614). If the process determines that the size of the free buffer removed in step 610 is not equal to or greater than the buffer size requested by the requestor component (“no” path of step 614), the process returns to selecting more donor components for removing more free buffers in steps 608 and 610.

Once the process determines that the total size of the removed free buffers is equal to or greater than the buffer size requested by the requestor component (“yes” path of step 614), the process combines the removed free buffers and allocates the removed free buffers to the requestor component (step 616). The process ends thereafter. Combining the removed free buffers in this manner produces a combined free buffer that may not be formed of contiguous memory spaces in the memory. However, the combined free buffer, having a combined size, logically appears as a single buffer to the requester component.

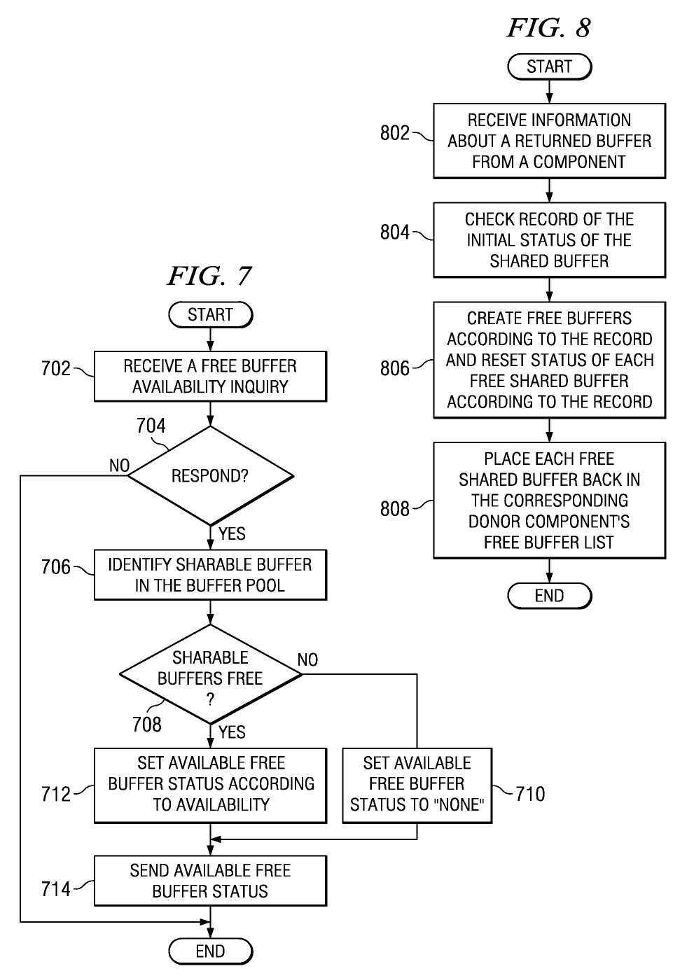

With reference now to FIG. 7, this figure depicts a flowchart of a process of responding to a free buffer availability inquiry in accordance with an illustrative embodiment. The process of this flowchart can be implemented in a donor component, such as data processing system component 302 in FIG. 3.

The process begins by receiving a free buffer availability inquiry (step 702). This inquiry is the inquiry sent in step 604 in FIG. 6. A data processing system component may choose not to be a donor component and not respond to this inquiry. In specific implementations of the illustrative embodiment, a data processing system component may be configured to determine when to respond and when not to respond based on certain conditions existing in the data processing system.

The process next determines whether to respond to the free buffer availability inquiry (step 704). If the process determines not to respond (“no” path of step 704), the process ends. If the process decides responds (“yes” path of step 704), the process identifies sharable free buffers in the data processing system component's buffer pool (step 706). As described above, a data processing system component may share only a part of its buffer pool. The buffers that the data processing system component decides to share are sharable buffers. Sharable buffers that are free and available for sharing are free sharable buffers.

A data processing system component may maintain a list of free sharable buffers in a free buffer list as described above. A sharable buffer may not be free for at least two reasons. The sharable buffer may have already been shared, or the sharable buffer may have been used up the data processing system component to whose buffer pool the sharable buffer belongs. Other reasons for non-availability of free sharable buffers will depend on specific implementations.

Next, the process determines if any sharable buffers in the data processing system component's buffer pool are free (step 708). Note that in specific implementations steps 706 and 708 may be combined, or step 706 may be eliminated as needed, without departing from the spirit of the illustrative embodiment.

If the process determines that none of the sharable buffers are free and available for sharing (“no” path of step 708), the process sets the available free buffer status to indicate that no free buffers are available (step 710). The available free buffer status may take the form of a flag set in the data processing system, a flag set in the data processing system component, or another suitable form. A flag is a piece of data that indicates a status. The process then sends the free buffer availability status (step 714). The process ends thereafter.

If the process determines that some of the sharable buffers are free to be shared (“yes” path of step 708), the process sets the available free buffer status to the appropriate value to indicate the availability (step 712). The process then sends the free buffer availability status (step 714). The process ends thereafter.

With reference now to FIG. 8, this figure depicts a flowchart of a process for returning the shared free buffers to the correct donor components in accordance with an illustrative embodiment. The process can be implemented in a buffer agent, such as buffer agent 316 in FIG. 3.

As described above, a requestor component requests additional buffers when the requester component faces a shortage of buffers. The buffer agent allocates a combined free buffer to the requestor component to fulfill that request. When the requestor component has buffers available in the requester component's own buffer pool, the requester component no longer needs the allocated combined free buffer, and returns the combined free buffer to the buffer agent. Note that if the buffer agent allocates a single free buffer to the requester component, the requestor component returns the single free buffer. If the buffer agent allocates a combined free buffer to the requester component, the requester component returns the combined free buffer.

The process begins by receiving information from a requester component about a buffer being returned (step 802). The process checks a record, such as table 400 in FIG. 4, to determine the composition of the returned buffer (step 804). As described above, a returned buffer may have been originally formed using several free buffers from several donor components. Therefore, the process determines in step 804 how to breakdown the returned buffer in order to return each of the free buffers to their respective, correct donor components.

From the determination made in step 804, the process decomposes the returned buffer into the free buffers that together formed the returned buffer. Decomposition of a buffer is the breaking down of the buffer into smaller buffers that were combined together originally to form the buffer. For example, if a buffer A was originally formed using smaller buffers B, C, and D, then the decomposition of buffer A is braking down the buffer A into buffers B, C, and D.

This decomposition of the returned buffer results in a set of returned free buffers, which is a collection of one or more returned free buffers. The process resets the status of each free buffer to the free buffer's status when the free buffer was shared (step 806). Status of the free buffer includes, but is not limited to, setting the buffer type of the free buffer to the buffer type according to an entry in column 410 in FIG. 4, and ensuring the size of the free buffer to be the size in the appropriate row of column 408 in FIG. 4.

Next, the process places the free buffer back into the free buffer list of the correct donor component (step 808). Step 808 may include showing the availability of the free buffer in the free buffers list of the correct donor component according to an entry in column 406 in FIG. 4. The process ends thereafter.

The process in FIG. 8 depicts the steps in the manner shown for clarity of the description of the illustrative embodiment. One of ordinary skill will be able to add additional steps, and increase or decrease the granularity of the steps shown in FIG. 8 according to specific implementation of the process from this disclosure.

Thus, the illustrative embodiments enable data processing system components in a data processing system to share free buffers among themselves. A buffer agent facilitates the process of requesting additional buffers, forming buffers of the requested size from free buffers, and returning the free buffers when the requested additional buffer is returned.

Because data processing system components can have access to additional buffers in the illustrative embodiments, the data processing system components can perform more operations, or operate longer and with shorter delay, as compared to when the data processing system components only have access to their own buffer pools. In enabling sharing of free buffers in this manner, the illustrative embodiments improve the performance of the data processing system components of the data processing system, and the performance of the data processing system as a whole.

The illustrative embodiments can additionally keep a record of the requests made by the various data processing system components for additional buffers over a period of time. Using this record, a user, such as a system administrator, can determine if the allocated memory for certain data processing system components should be increased or decreased. For example, the system administrator may increase the allocated memory for a data processing system component that makes several requests for additional buffers, and decrease the allocated memory for a data processing system component that makes no request for additional buffers in a given period of time. This adjustment of allocated memory is a re-leveling of resource allocation in a data processing system. In this manner, using the illustrative embodiments, a data processing system results in improved resource utilization as compared to the resource utilization in a data processing system without the illustrative embodiments.

The illustrative embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the illustrative embodiments has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing a plurality of buffers, the computer implemented method comprising:
responsive to receiving a request from a requesting component in a data processing system for a buffer of a first size, determining whether a set of free buffers of any size each is available from a set of donor components such that a combined size of the free buffers in the set of free buffers is equal to or greater than the first size;
if the set of free buffers is available, combining the free buffers in the set of free buffers to form a combined free buffer;
removing the set of free buffers from a free buffer list for a corresponding donor component; and
reallocating the combined free buffer to the requesting component.

2. The computer implemented method of claim 1, further comprising:
updating a record with first information about each free buffer in the set of free buffers, wherein the first information comprises a buffer identifier, a buffer type, and a corresponding donor component identifier; and
updating the record with second information about the combined free buffer, wherein the second information comprises a combined free buffer identifier and a requestor component identifier; and
correlating the first information with the second information, forming an entry in the record.

3. The computer implemented method of claim 2, wherein the buffer identifier is an address of the buffer.

4. The computer implemented method of claim 1, further comprising:
updating a record with information about the request, wherein the information about the request comprises a requestor component identifier and a buffer type; and
adjusting an allocated memory for a component identified by the requestor component identifier using the record.

5. The computer implemented method of claim 1, further comprising:
receiving a returned combined free buffer from the requester component, wherein the returned combined free buffer is the combined free buffer previously assigned to the requester component being returned after use by the requester component;
decomposing the returned combined free buffer to form a set of returned free buffers according to the entry in the record, wherein each returned free buffer in the set of returned free buffers is a free buffer in the set of free buffers; and
placing each returned free buffer in a free buffer list of a corresponding component of the returned free buffer.

6. A computer usable program product comprising a computer usable medium including computer usable code for managing a plurality of buffers, the computer usable program product comprising:
computer usable code for, responsive to receiving a request from a requesting component in a data processing system for a buffer of a first size, determining whether a set of free buffers of any size each is available from a set of donor components such that a combined size of the free buffers in the set of free buffers is equal to or greater than the first size;
computer usable code for, if the set of free buffers is available, combining the free buffers in the set of free buffers to form a combined free buffer;
computer usable code for removing each free buffer in the set of free buffers and from a free buffer list of a corresponding donor component; and
computer usable code for reallocating the combined free buffer to the requesting component.

7. The computer usable program product of claim 6, further comprising:
computer usable code for updating a record with first information about each free buffer in the set of free buffers, wherein the first information comprises a buffer identifier, a buffer type, and a corresponding donor component identifier; and
computer usable code for updating the record with second information about the combined free buffer, wherein the second information comprises a combined free buffer identifier, and a requestor component identifier; and
computer usable code for correlating the first information with the second information, forming an entry in the record.

8. The computer usable program product of claim 7, wherein the buffer identifier is an address of the buffer.

9. The computer usable program product of claim 6, further comprising:
computer usable code for updating a record with information about the request, wherein the information about the request comprises a requester component identifier, and a buffer type; and
computer usable code for adjusting an allocated memory for a component identified by the requester component identifier using the record.

10. The computer usable program product of claim 6, further comprising:
computer usable code for receiving a returned combined free buffer from the requestor component, wherein the returned combined free buffer is the combined free buffer previously assigned to the requester component being returned after use by the requester component;
computer usable code for decomposing the returned combined free buffer to form a set of returned free buffers according to the entry in the record, wherein each returned free buffer in the set of returned free buffers is a free buffer in the set of free buffers; and
computer usable code for placing each returned free buffer in a free buffer list of a corresponding component of the returned free buffer.

11. A data processing system for managing a plurality of buffers, comprising:
a storage device, wherein the storage device stores computer usable program code; and
a processor, wherein the processor executes the computer usable program code, and wherein the computer usable program code comprises:
computer usable code for, responsive to receiving a request from a requesting component in a data processing system for a buffer of a first size, determining whether a set of free buffers of any size each is available from a set of donor components such that a combined size of the free buffers in the set of free buffers is equal to or greater than the first size;
computer usable code for, if the set of free buffers is available, combining the free buffers in the set of free buffers to form a combined free buffer;
computer usable code for removing each free buffer in the set of free buffers and from a free buffer list of a corresponding donor component; and
computer usable code for reallocating the combined free buffer to the requesting component.

12. The data processing system of claim 11, further comprising:
computer usable code for updating a record with first information about each free buffer in the set of free buffers, wherein the first information comprises a buffer identifier, a buffer type, and a corresponding donor component identifier; and
computer usable code for updating the record with second information about the combined free buffer, wherein the second information comprises a combined free buffer identifier, and a requestor component identifier; and
computer usable code for correlating the first information with the second information, forming an entry in the record.

13. The data processing system of claim 12, wherein the buffer identifier is an address of the buffer.

14. The data processing system of claim 11, further comprising:
computer usable code for updating a record with information about the request, wherein the information about the request comprises a requestor component identifier, and a buffer type; and
computer usable code for adjusting an allocated memory for a component identified by the requester component identifier using the record.

15. The data processing system of claim 11, further comprising:
computer usable code for receiving a returned combined free buffer from the requester component, wherein the returned combined free buffer is the combined free buffer previously assigned to the requester component being returned after use by the requestor component;
computer usable code for decomposing the returned combined free buffer to form a set of returned free buffers according to the entry in the record, wherein each returned free buffer in the set of returned free buffers is a free buffer in the set of free buffers; and
computer usable code for placing each returned free buffer in a free buffer list of a corresponding component of the returned free buffer.

16. A system for managing a plurality of buffers, the computer implemented method comprising:
a plurality of components in communication with the buffer agent;
a memory, wherein each component in the plurality of components has a buffer pool in an allocated portion of the memory; and
a buffer agent, wherein the buffer agent, responsive to receiving a request from a requesting component in the system for a buffer of a first size, determines whether a set of free buffers of any size each is available from a set of donor components such that a combined size of the free buffers in the set of free buffers is equal to or greater than the first size, wherein if the set of free buffers is available, the buffer agent combines the free buffers in the set of free buffers to form a combined free buffer, wherein the buffer agent removes each free buffer in the set of free buffers and from a free buffer list of a corresponding donor component, and wherein the buffer agent reallocates the combined free buffer to the requesting component.

17. The system of claim 16, further comprising:
the buffer agent updates a record with first information about each free buffer in the set of free buffers, wherein the first information comprises a buffer identifier, a buffer type, and a corresponding donor component identifier; and
the buffer agent updates the record with second information about the combined free buffer, wherein the second information comprises a combined free buffer identifier, and a requester component identifier; and
the buffer agent correlates the first information with the second information, forming an entry in the record.

18. The system of claim 17, wherein the buffer identifier is an address of the buffer, and wherein the buffer agent either runs as a kernel thread with a high priority or is accessible using an interrupt.

19. The system of claim 16, further comprising:
the buffer agent updates a record with information about the request, wherein the information about the request comprises:
a requester component identifier; and
a buffer type; and
adjusts an allocated memory for a component identified by the requester component identifier using the record.

20. The system of claim 16, further comprising:
the buffer agent receives a returned combined free buffer from the requester component, wherein the returned combined free buffer is the combined free buffer previously assigned to the requester component being returned after use by the requester component;
the buffer agent decomposes the returned combined free buffer to form a set of returned free buffers according to the entry in the record, wherein each returned free buffer in the set of returned free buffers is a free buffer in the set of free buffers; and
the buffer agent places each returned free buffer in a free buffer list of a corresponding component of the returned free buffer.
